(19) United States
(12) Patent Application Publication
(10) Pub. No.: US 2007/0181016 A1
(43) Pub. Date: Aug. 9, 2007

(54) Printing machine

(75) Inventor: Johannes Georg Schaede, Wurzburg (DE)

Correspondence Address: CROMPTON, SEAGER & TUFTE, LLC, 1221 NICOLLET AVENUE, SUITE 800, MINNEAPOLIS, MN, 55403-2420, US

(73) Assignee: KBA-GIORI S.A., Lausanne (CH)

(21) Appl. No.: 11/569,264

(22) PCT Filed: May 30, 2005
(86) PCT No.: PCT/IB05/01547

§ 371 Date: Nov. 17, 2006

(30) Foreign Application Priority Data
Jun. 3, 2004 (EP) 04013136.9

(51) Int. Cl. B41F 9/02

(52) U.S. Cl. 101/152

(57) ABSTRACT

The machine comprises at least a transfer cylinder, an impression cylinder, a plate cylinder, a collector cylinder, and a delivery cylinder, each said impression cylinder, plate cylinder and collector cylinder comprising pits with, respectively, gripping means, clamping means and holding means for holding, respectively, at least one sheet, at least one plate and at least one blanket. The number of pits per cylinder and the relative position of said cylinders are such that the pits of the impression cylinder, plate cylinder and collector cylinder pass each other at the same moment during operation of the printing machine.

The present invention concerns an intaglio printing machine, for printing documents, securities, bank-notes, checks and other similar documents.

Such printing machines are known per se in the art of printing. For example, European patent applications EP 0 982 125 and 0 982 131 disclose such printing machines. Other prior art publications, the content of which is incorporated by reference in the present application for the sake of completeness regarding the present technology, include U.S. Pat. No. 4,516,496, showing a similar printing machine.

U.S. Pat. No. 5,062,359 relates to an intaglio printing machine for the printing of currency papers, i.e. securities. This patent is incorporated by reference in the present application with regards to the printing technology disclosed. This machine comprises at least an impression cylinder, a plate cylinder interacting with the latter and a collector inking cylinder in contact with the plate cylinder and a wiping system. The plate cylinder is equipped with several engraved printing plates distributed uniformly. The collector inking cylinder has an elastic surface and is equipped with several blankets. Along the periphery of the collector inking cylinder and in contact with said cylinder, selective color inking cylinder are mounted, each being inked by means of its own inking device. In this machine all cylinders comprise three cylinder pits in which gripper systems are mounted to hold, respectively, the sheet being printed, the plates and the rubber blankets.

Another known machine is disclosed in U.S. Pat. No. 5,899,145, the content of which is enclosed by reference in the present application with regards to the printing technology. The known machine includes a plate cylinder, an impression cylinder, a wiping device and an inking system comprising a collector inking cylinder and color selector cylinders. In the disclosed configuration, the collector cylinder comprises two cylinder pits, the plate cylinder comprises three cylinder pits and the impression cylinder comprises three cylinder pits.

A further machine is known from the published Japanese abstract PAJ 60015158. In this abstract, the figure shows an intaglio printer with a plurality of effective surfaces with an identical circular angle and a plurality of ineffective surfaces with an identical circular angle are alternately provided to an intaglio plate cylinder and an impression cylinder.

A problem that has been encountered with the known machines is the fact that due to the high pressure between the impression cylinder and the plate cylinder, when cylinder pits of each cylinder encounter each other, a vibration is generated in both cylinders, which has an effect on the preciseness of the inking by the inking cylinder. Of course, any vibration of the impression cylinder will slightly modify the register of both the plate cylinder and of the inking cylinder: due to the small size of the engravings in the plates of the plate cylinder, the inking will effectively be less precise, and this will be carried on to the printing process per se, on the printed sheets. The quality of the printing process is thus diminished and more sheets with misprints are produced.

It is therefore an aim of the present invention to improve the known printing machines.

More specifically, it is a further aim of the present invention to provide a printing machine, which has an improved quality printing.

Another aim of the present invention is to provide a printing machine which able to carry out a precise inking of the plates.

To this effect, the present invention complies with the definition of the claims.

The idea in the machine according to the present invention is to provide configurations of cylinders in which all pits of the cylinders are in phase with each other, meaning that the pits of the impression cylinder, the plate cylinder and the collector cylinder pass each other at the same moment during operation of the machine so that one avoids a vibration in the plate cylinder during the inking by the collector cylinder.

This effect can be obtained by using several parameters including the number of pits, the diameter of the cylinders and the relative positions the cylinders with respect to each other.

The invention will be better understood by the detailed description of three different embodiments and the drawings in which

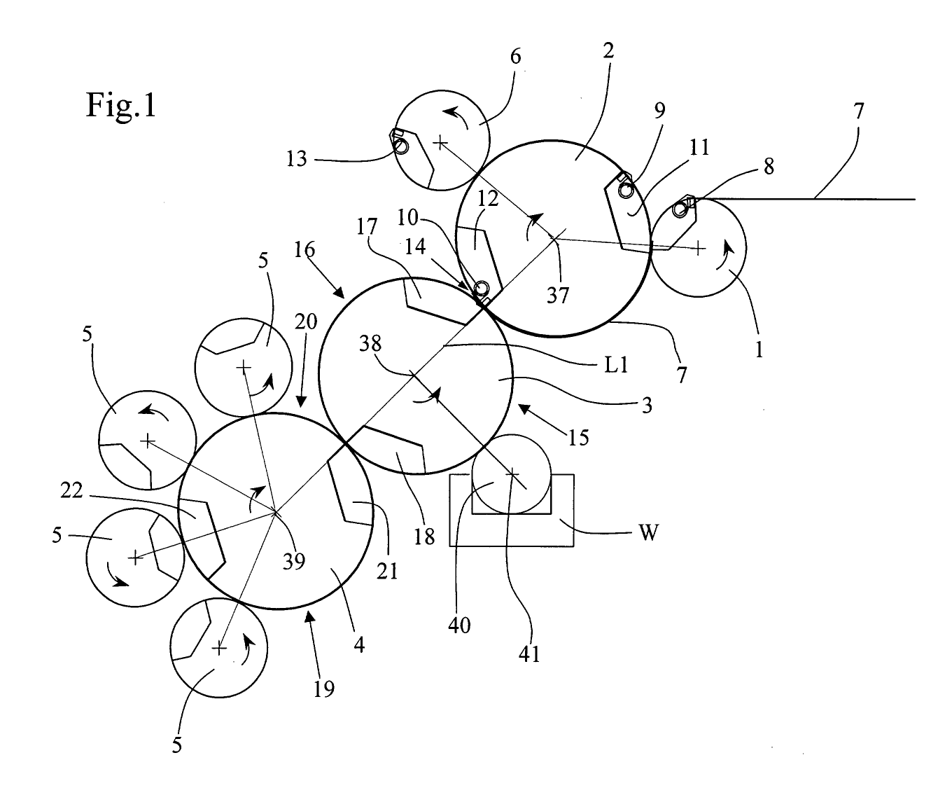

FIG. 1 shows a first embodiment of the printing machine according to the invention;

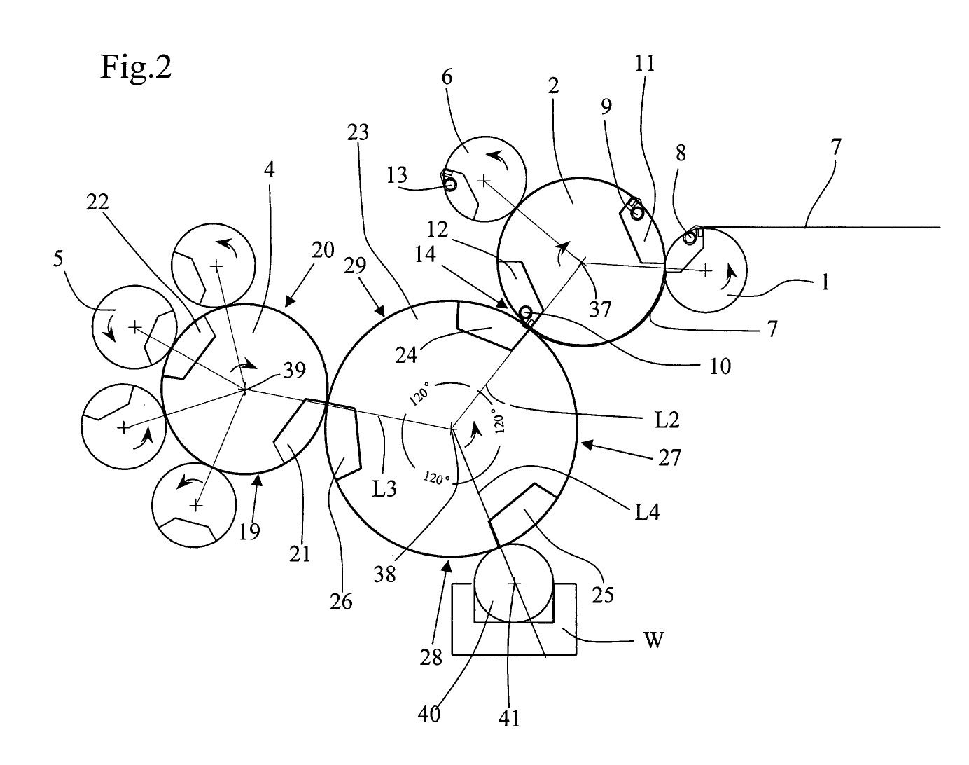

FIG. 2 shows a second embodiment of the printing machine according to the invention and

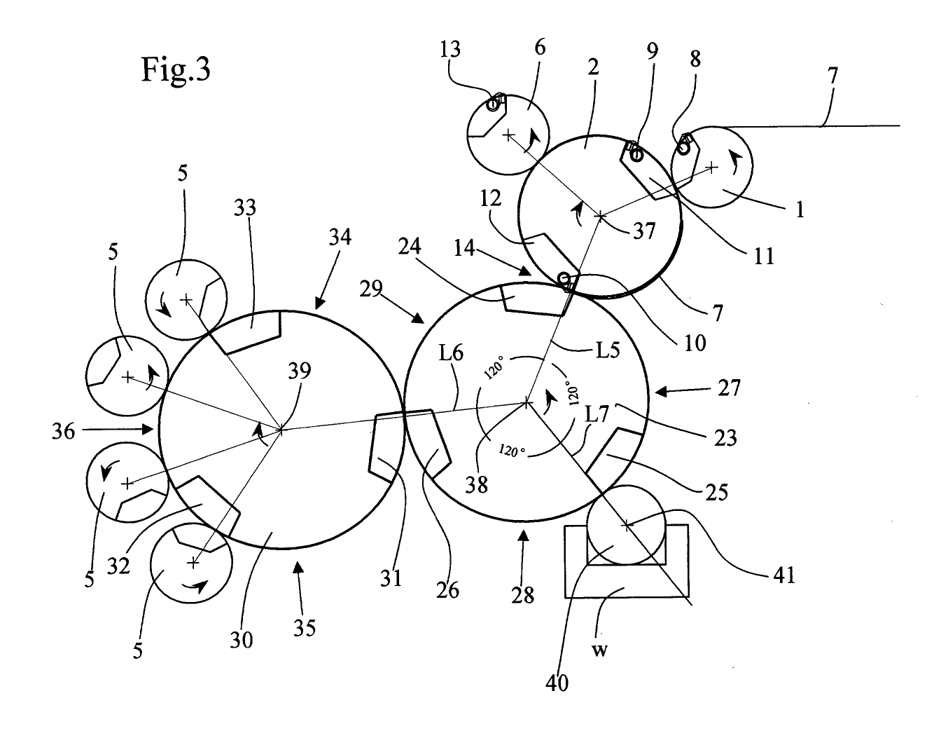

FIG. 3 shows a third embodiment of the printing machine according to the invention.

In the first embodiment of FIG. 1, the printing machine comprises a transfer cylinder 1 with a gripper 8 for feeding the machine with sheets 7 to be printed, an impression cylinder 2 on which the sheets 7 are held by grippers 9, 10 located in impressions cylinder pits 11, 12 during the impression process and a delivery chain cylinder 6 with a gripper 13 for taking away the printed sheets 7.

The impression cylinder 2 cooperates with a plate cylinder 3 forming a printing nip 14 between them, through which nip 14 the sheets 7 pass during the printing operation per se.

The plate cylinder 3 supports printing plates, schematically identified by references 15 and 16, through holding means, such as clamping devices or other equivalent means known in the art of printing machines, which are located in plate cylinder pits 17 and 18.

The plates 15, 16 of the plate cylinder 3 are inked, in this example, by a collector cylinder 4, which supports rubber blankets 19, 20 on which the ink of the various colors is deposited for inking the plates 15, 16, as is known in the prior art of printing. The collector cylinder 4 also comprises collector cylinder pits 21, 22 in which blanket holding and tensioning devices are located to hold the rubber blankets 19, 20 onto the collector cylinder as is known for example from U.S. Pat. No. 4,584,942, incorporated herein.

The blankets 19, 20 of the collector cylinder 4 are inked by several selective inking cylinders 5 which are used to deposit the ink of each color on said blankets 19, 20.

In the configuration shown in this FIG. 1, the impression cylinder 2, the plate cylinder 3 and the collector cylinder 4 all have the same diameter, the same number of cylinder pits (two) and their axis are aligned along a same straight line segment L1. Accordingly, by appropriate adjustment of the position of these cylinders, it is possible to have all cylinder pits in phase with each other, thus avoiding the creation of vibration in the plate cylinder 3 during the inking process by the collector cylinder 4 as the pits 11, 18, respectively 12, 17 cross each other. As has been represented in FIG. 1, the beginning of cylinder pits 12, 17, 18 and 21, with respect to the rotation of the cylinders 2, 3 and 4 are all aligned on said line segment L1, as are the respective axis 37, 38 and 39 of said cylinders 2, 3 and 4. Therefore when a vibration is generated in the plate cylinder 3, the inking process has not started and one has some time to attenuate the vibration (for example with appropriate damping means) before the inking process of the plates 15, 16 starts.

In this figure, a wiping unit W is represented to wipe the ink which is on the plates 15 and 16 but outside the engravings of said plates, as is usual in the printing technology. This wiping unit typically comprises a wiping roller 40 with an axis 41.

In FIG. 2, a second configuration of the printing machine according to the invention is shown. In this configuration, the part of the machine concerning the delivery and take away of the sheets 7 is similar to the first configuration with a transfer cylinder 1 with a gripper 8 for feeding the machine with sheets 7 to be printed, an impression cylinder 2 on which the sheets 7 are held by grippers 9, 10 located in impression cylinder pits 11, 12 during the impression process and a delivery chain cylinder 6 with a gripper 13 for taking away the printed sheets 7.

The impression cylinder cooperates with a plate cylinder 23 forming the printing nip 14 between them.

The plate cylinder 23 comprises in this configuration three plate cylinder pits 24, 25 and 26 in which, as is known in the art, clamping means are provided to maintain plates 27, 28 and 29 on the cylinder 23.

To ink the plates 27, 28, 29 of the plate cylinder 23, one uses, as in the first configuration, a collector cylinder 4, which supports the rubber blankets 19, 20 on which the ink of the various colors is deposited for inking the plates 27, 28, 29, as is known in the art of printing. The collector cylinder 4 comprises collector cylinder pits 21, 22 in which blanket holding and tensioning devices are located to hold the rubber blankets 19, 20 onto the collector cylinder 4 as is known for example from U.S. No. Pat. 4,584,942, incorporated herein by reference.

The collector cylinder 4 is inked by several selective inking cylinders 5 which are used to deposit the ink of each color on the blankets 19, 20 of the collector cylinder 4, as known in the art of printing.

In this configuration, the impression cylinder 2 and the collector cylinder 4 have the same diameter and both two cylinder pits 11, 12, 21, 22 whereas the plate cylinder 23 has three cylinder pits 24, 25, 26. Hence the diameter of cylinders 2 and 4 is equal to ⅔ of the diameter of the plate cylinder 23. The relative position of the cylinders is also adjusted in order to be able to put all the cylinders pits in phase, in accordance with the principle of the present invention, and as shown in FIG. 2. The angle between two line segments L2, L3 linking the axis 37, 38 and 39 of each cylinder 2, 23, 4 is about 120° as can be seen in this FIG. 2.

In this FIG. 2, a wiping unit W is represented to wipe the ink which is on the plates 27, 28 and 29 but outside the engravings of said plates, as is usual in the printing technology. The wiping unit is situated such that the wiping roller 40 is also in phase with the cylinder pits 24, 25, 26, as shown in the FIG. 2, so that the wiping operation of plate (plate 28 in FIG. 2) takes place during the printing carried out with plate 27 and during the inking of plate 29, i.e. that the wiping roller 40 does not pass a pit when the printing and inking operations are carried out with the plates, hence avoiding the generation of vibrations.

As shown in this figure the angle between the two line segments L2 L3 and the line segment L4 linking the axis 38 of the cylinder 23 and the axis 41 of the wiping roller 40 is about 120°.

A third configuration is shown in FIG. 3. As represented, the printing machine comprises a transfer cylinder 1 with a gripper 8 for feeding the machine with sheets 7 to be printed, an impression cylinder 2 on which the sheets 7 are held by grippers 9, 10 located in impressions cylinder pits 11, 12 during the impression process and a delivery chain cylinder 6 with a gripper 13 for taking away the printed sheets 7.

The impression cylinder 2 cooperates with a plate cylinder 23 forming a printing nip 14 between them, through which nip 14 the sheets 7 pass during the printing operation per se.

The plate cylinder in this configuration is identical to the plate cylinder of the second configuration, with three pits 24, 25 and 26 for holding the three plates 27, 28 and 29.

The collector cylinder 30 in this configuration has three pits 31, 32 and 33 for holding three rubber blankets 34, 35 and 36 which are inked by several selective inking cylinders 5 which are used to deposit the ink of each color on the blankets 34, 35, 36 of the collector cylinder 30, as is known in the art of printing.

In this configuration also, the number of pits and the relative positions of the cylinder are such that the pits are in phase with each other to allow a precise inking of the plate, according to the present invention. Hence, in the position represented, pits 12 and 24, and pits 26 and 31 are aligned as shown as shown in FIG. 3. The angle between two line segments L5, L6 linking the axis 37, 38 and 39 of each cylinder 2, 23, 30 is about 120° as can be seen in this FIG. 3 and accordingly avoid generation of vibrations in the plate cylinder during the inking operation.

In this FIG. 3, a wiping unit W is represented to wipe the ink which is on the plates 27, 28 and 29 but outside the engravings of said plates, as is usual in the printing technology. The wiping unit is situated such that the wiping roller 40 is also in phase with the cylinder pits 24, 25, 26, as shown in FIG. 3, so that the wiping operation of plate (plate 28 in FIG. 3) takes place during the printing carried out with plate 27 and during the inking of plate 29, i.e. that the wiping roller does not pass a pit when the printing and inking operations are carried out with the plates, hence avoiding the generation of vibrations.

As shown in this figure the angle between the two line segments L5, L6 and the line segment L7 linking the axis 38 of the cylinder 23 and the axis 41 of the wiping roller 40 is about 120°.

As can be understood from the present description, the respective positions of the printing cylinder, the plate cylinder and the collector cylinder depend on the number of pits present in the plate cylinder. If this cylinder comprises two pits (diametrally placed), the impression cylinder and collector cylinder will be aligned on a same straight line to ensure synchronism. If the plate cylinder comprises three pits (disposed every 120°), the angle between the segments of lines linking the axis of the impression cylinder, collector cylinder and plate cylinder will be 120°, independently of the number of pits present on the impression cylinder and the collector cylinder. The same reasoning can be followed if the plate cylinder comprises 4 pits, i.e. every 90°. As a general rule, if N is the number of pits in the plate cylinder, the angle between the segments of lines linking the axis of the impression cylinder, collector cylinder and plate cylinder will be 360°/N.

Of course, the present invention is not limited to the disclosed configurations which are given by way of non-limiting examples. Other configurations could be envisaged that would fulfill the aim of the present invention.

1. An intaglio printing machine for printing successive sheets of documents, such as securities and other similar documents, comprising at least a transfer cylinder, an impression cylinder, a plate cylinder, a collector cylinder, and a delivery cylinder, each said impression cylinder, plate cylinder and collector cylinder comprising pits with, respectively, gripping means, clamping means and holding means for holding, respectively, at least one sheet, at least one plate and at least one blanket, wherein the number of pits per cylinder and the relative position of said cylinders are such that the pits of the impression cylinder, the plate cylinder and the collector cylinder pass each other at the same moment during operation of the printing machine.

2. An intaglio printing machine as claimed in claim 1, wherein said impression cylinder comprises two impression cylinder pits, said plate cylinder comprises two plate cylinder pits and said collector cylinder comprises two collector cylinder pits.

3. An intaglio printing machine as claimed in claim 1, wherein the axis of said impression cylinder, said plate cylinder and said collector cylinder are aligned on a straight line.

4. An intaglio printing machine as claimed in claim 1, wherein said impression cylinder comprises two impression cylinder pits, said plate cylinder comprises three plate cylinder pits and said collector cylinder comprises two collector cylinder pits.

5. An intaglio printing machine as claimed in claim 1, wherein said impression cylinder comprises two impression cylinder pits, said plate cylinder comprises three plate cylinder pits and said collector cylinder comprises three collector cylinder pits.

6. An intaglio printing machine as claimed in claim 1, wherein the axis of said impression cylinder, said plate cylinder and said collector cylinder are placed on two straight segments of lines, said segments of lines having a predetermined angle between them.

7. An intaglio printing machine as claimed in claim 6, wherein said predetermined angle is 120°.

8. An intaglio printing machine as claimed in claim 2, wherein the axis of said impression cylinder, said plate cylinder and said collector cylinder are aligned on a straight line.

9. An intaglio printing machine as claimed in claim 4, wherein the axis of said impression cylinder, said plate cylinder and said collector cylinder are placed on two straight segments of lines, said segments of lines having a predetermined angle between them.

10. An intaglio printing machine as claimed in claim 9, wherein said predetermined angle is 120°.

11. An intaglio printing machine as claimed in claim 5, wherein the axis of said impression cylinder, said plate cylinder and said collector cylinder are placed on two straight segments of lines, said segments of lines having a predetermined angle between them.

12. An intaglio printing machine as claimed in claim 11, wherein said predetermined angle is 120°.
